(19) United States
(12) Patent Application Publication
(10) Pub. No.: US 2026/0037569 A1
(43) Pub. Date: Feb. 5, 2026

(54) PLAY ONE THEN STOP BUTTON IN MEDIA PLAYER

(71) Applicant: Legacy Productions, Inc. d/b/a Easy Song, Minneapolis, MN (US)

(72) Inventor: Mark Jardine Meikle, Chanhassen, MN (US)

(21) Appl. No.: 19/290,967

(22) Filed: Aug. 5, 2025

Related U.S. Application Data
(60) Provisional application No. 63/679,475, filed on Aug. 5, 2024.

(51) Int. Cl. G06F 16/438; G06F 3/04817; G06F 3/04842

(52) U.S. Cl. CPC G06F 16/4387; G06F 3/04817; G06F 3/04842

(57) ABSTRACT

A method and system are provided for controlling playback of media objects in a media application. The method includes outputting a first media object from a playlist of media objects, wherein the media application is configured to automatically begin outputting a subsequent media object upon completion of the first. While the first media object is being output, the system receives an indication of user input selecting a graphical icon in the application's graphical user interface. In response, the system continues outputting the first media object to completion and, upon completion, refrains from outputting the next media object in the playlist. Multiple selections of the graphical icon may cause playback to continue for a corresponding number of media objects before stopping.

### RELATED APPLICATIONS

This application claims the benefit of U.S. Provisional Application No. 63/679,475, filed Aug. 5, 2024, the entire contents of which are incorporated herein by reference.

### TECHNICAL FIELD

The disclosure relates to media player functions.

### BACKGROUND OF THE INVENTION

Over time, digital media players have become ubiquitous components of modern computing devices, providing users with robust interfaces to organize and consume audio and video content. A digital media player generally enables the creation and management of sequential or shuffled playback of a series of media items. Typical interfaces present controls for play, pause, skip, and navigation among tracks or videos. Moreover, integration with local libraries and online streaming services offers seamless access to diverse content without disrupting the user experience.

Many playback applications support repeat modes that permit continuous playback. Specifically, users typically toggle between a mode that repeats the entire sequence of items and a mode that repeats a single item. However, these modes do not accommodate scenarios in which a user intends to play precisely one item and then cease playback automatically.

As a result, users may find themselves either stopping playback prematurely or frequently monitoring the interface to prevent unwanted continuation. Current approaches do not provide a specific mechanism to play a single item and then halt playback upon the completion of that item. This often leads users to rely on manual actions, such as pausing mid-track or turning off repeat features just before the desired item concludes, which can disrupt the playback experience and require careful timing. Additionally, once a new song begins streaming, data packets will be received over the network for the new song, leading to extraneous data being transmitted over the network when it is not desired.

### SUMMARY

A media application is provided that allows a user to control playback of a playlist of media objects, such as audio, video, or image files. The media application includes a graphical user interface with a graphical icon that, when selected by the user during playback of a media object, causes the application to continue outputting the current media object to completion and then stop playback, refraining from automatically playing the next media object in the playlist. The application may also allow the user to place a graphical marker in the playlist to indicate where playback is intended to cease.

This approach provides users with increased flexibility and control over media playback, addressing the need to stop playback automatically after a selected media object without requiring manual intervention at the precise moment playback is intended to end. This method removes the inconvenience of either stopping playback prematurely or having to monitor the application to prevent unwanted continuation to the next media object, which may consume extra data and increase network traffic. The visual feedback provided by the graphical icon or marker further improves the user experience by clearly indicating the point at which playback will stop.

In one example, a method includes outputting a first media object in a media application as part of a playlist, where the application is configured to automatically begin outputting a second media object upon completion of the first. While outputting the first media object, the application receives user input selecting a graphical icon in the user interface. In response, the application continues to output the first media object to completion and, upon completion, refrains from outputting the second media object.

In another example, upon receiving the user input selecting the graphical icon, the application refrains from outputting any additional media objects in the playlist after the first media object is completed. The first media object may be an audio, video, or image object.

The application may update the appearance of the graphical icon in the user interface to indicate that playback will cease upon completion of the current media object. After refraining from outputting the next media object, the application may receive a second user input selecting a different graphical icon and, in response, output the next media object.

In further examples, the application may be configured so that, after completion of the second or third media object, multiple selections of the graphical icon during playback of the first media object result in sequential completion of the first, second, and third media objects before refraining from outputting any subsequent media object. In the case of a media streaming application, the application refrains from requesting or receiving any data packets for the next media object from a server after completion of the current media object.

The application may also output a notification to the user indicating that playback will stop after the current media object, receive user input via voice command or touch input, and prompt for authentication before enabling the function to refrain from outputting subsequent media objects.

In another example, the application displays a graphical user interface showing a portion of a playlist, receives user input to place a graphical marker between two media objects, and, upon completion of the first media object, refrains from outputting the second media object based on the placement of the marker. The application may also refrain from outputting any additional media objects after the marker, and may output the next media object in response to further user input.

A non-transitory computer-readable storage medium is also provided, storing instructions that, when executed, cause a computing device to perform any of the methods described above.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a conceptual diagram illustrating an example user interface of a music application that incorporates the play one then stop function, in accordance with the techniques described herein.

FIG. 2 is a block diagram illustrating a more detailed example of a computing device configured to perform the techniques described herein.

FIG. 3 is a conceptual diagram illustrating an example of a play one then stop icon with an informational badge, in accordance with the techniques described herein.

FIG. 4 is a conceptual diagram illustrating an example user interface of a music application that utilizes a graphical marker placed between songs to indicate where the playlist should stop, in accordance with one or more of the techniques of this disclosure.

FIG. 5 is a flow diagram illustrating an example process of activating a play one then stop icon, in accordance with one or more of the techniques of this disclosure.

FIG. 6 is a flow diagram illustrating an example process of placing a graphical marker between items in a playlist to prematurely stop the output of the playlist, in accordance with one or more of the techniques of this disclosure.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

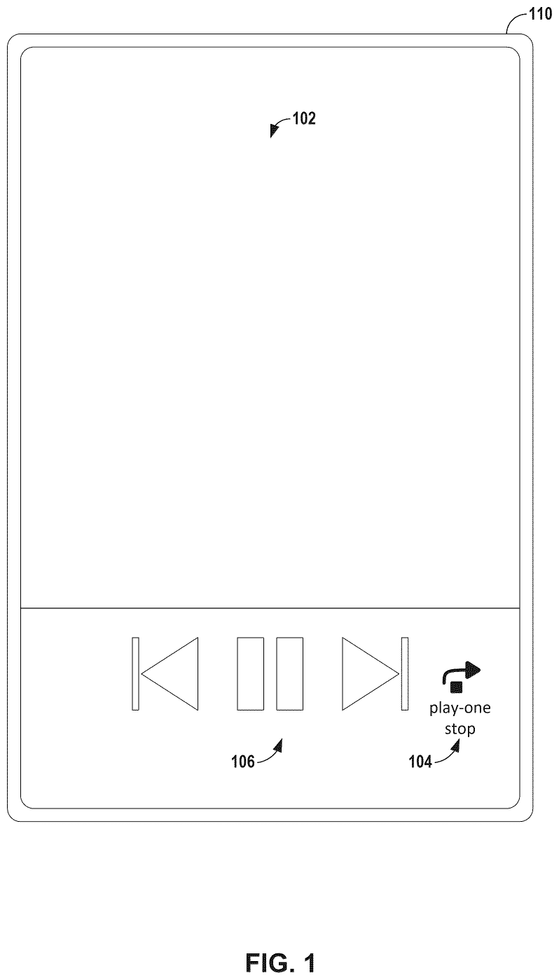

FIG. 1 is a conceptual diagram illustrating an example user interface 102 of a music application that incorporates the play one then stop function, in accordance with the techniques described herein. Computing device 110 may output user interface 102 to a display component of computing device 110. Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein. Computing device 110 may output user interface 102 while executing a media player application that, when executed, can further cause computing device 110 to output media objects, such as audio files, video files, or image files, among other things.

User interface 102 may include icons that include various functionality. This includes graphical icon 106, which, when computing device 110 receives an indication of user input at graphical user interface 102 selecting graphical icon 106, computing device 110 alternates between playing the media object or pausing the media object. In typical operation, once a user provides user input into computing device 110 to begin playing a media object, computing device 110 will continue to output various media objects in a playlist, starting to output a new media object in the playlist once the output of the previous media object is complete (e.g., the song finishes playing or the video has ended).

While outputting the media objects in a playlist, computing device 110 may receive an indication of user input at graphical icon 104, selecting the play-one then stop function. With this function, computing device 110 will continue to output the currently playing media object without interruption. Once computing device 110 completes the output of that media object (e.g., the song finishes playing or the video ends), computing device 110 may refrain from outputting any additional media objects, including a media object expected to be next in the playlist. If the user then provides input to graphical icon 106, computing device 110 may continue outputting the media object.

Graphical icon 104 represents the finish-one-then-stop function. This button would stop play after the currently playing song has finished. This would solve a problem that currently exists in media applications of having to choose between 1) stopping prematurely during play of a song, or 2) continuously monitoring the application to stop play after that song and prevent continuation to the next song.

The function can be toggled at any time. Once toggled, if music is playing, whichever single song is playing will play to conclusion, then the feature may trigger the player to stop playing audio/not play any additional songs (after the conclusion of that song). When toggled, if nothing is playing, the function may stay toggled until a song is started, at which point the previously-described functionality may take effect. The visual effect at the conclusion of execution of the function might vary by player. One use case may be the pause button changes to a play button, and the “play-one-stop” button is no longer active (e.g., dims or switches back to “repeat-all”). After the function takes effect, the position in the playlist will advance to the next song, but with the player or music stopped. If there are more songs, the next one may be highlighted, but not played. If the function is set on the last song, the playlist may reset to the beginning, but not play the audio (although this may differ by player). The visual effect at the start of the toggling of the function might vary, but may be the same sort of highlighted icon that transitions between repeat functions.

When the user presses play again after stopping in this manner, they can press play and continue listening to audio or video.

An extension of this technique is the ability to drop markers in the playlist. For instance, the user could long press the button to “pick up” a marker icon that the user can drop anywhere in the playlist to indicate the music should stop after playing that song. There may be some visual indicator either on the song segment that is the last to play, or just after it.

Media applications have become a significant component of modern computing devices, enabling users to consume audio, video, and other media content seamlessly. These applications often include playlists that allow for continuous playback of media objects, such as songs or videos, in a predefined sequence. However, conventional media applications lack a user-friendly mechanism to stop playback automatically after the completion of a single media object. Existing solutions typically require users to either manually stop playback during or after the media object or rely on limited repeat functions, such as “repeat-all” or “repeat-one,” which do not address the need for selective cessation of playback. This creates a cumbersome user experience, particularly for users who wish to listen to or view only one media object, or some set number of media objects, without the need to monitor the application to prevent the next item in the playlist from playing.

The present disclosure addresses these limitations by introducing “play one then stop” functionality within media applications. This concept allows users to toggle a specialized function that ensures playback of the currently playing media object continues uninterrupted until its completion, at which point the application automatically refrains from playing subsequent media objects in the playlist. Unlike conventional approaches, this solution eliminates the need for manual intervention or ongoing monitoring by the user, thereby enhancing usability and convenience.

The solution is implemented through a combination of system architecture enhancements and user interface modifications. Specifically, the described approach introduces a graphical icon within the media application's user interface that users can select to activate the “play one then stop” function. Upon activation, the system employs specialized algorithms to override the default playlist behavior, ensuring that playback ceases after the current media object concludes. Additionally, the system updates the appearance of the graphical icon to provide visual feedback, indicating that the function is active. The described approach also supports advanced features, such as the ability to place markers within a playlist to designate specific stopping points, further extending the functionality. By integrating these features, the described approach provides a streamlined and intuitive solution to a longstanding problem in media playback systems.

The subject matter described herein is directed to a specific improvement in the operation of media applications and computing devices. The present disclosure is directed to a concrete and practical solution to a technical problem in the field of digital media playback.

Specifically, the techniques described herein provide a method and system for controlling the output of media objects in a playlist, enabling a user to selectively halt playback after a desired media object is completed, without requiring manual intervention at the precise moment playback is to cease. This is achieved through the implementation of a specialized graphical user interface element and associated processing logic that modifies the default behavior of media applications. The techniques described herein further provide for dynamic user interaction, visual feedback, and integration with various types of media and computing platforms.

The technical solution described herein improves the functioning of media applications by providing enhanced user control, reducing unnecessary resource consumption (such as network or processing resources that would otherwise be used to load or play unwanted media objects), and enabling new modes of interaction not previously available in conventional systems. Accordingly, the techniques described herein provide a specific and practical implementation that transforms the operation of a media application and computing device.

One technical improvement realized by stopping a streaming application from automatically streaming the next media object in a playlist lies in the enhanced efficiency, user control, and resource management of the media playback system. Traditionally, streaming applications are configured to automatically request and buffer the next media object in a playlist as soon as the current media object nears completion. This default behavior can result in unnecessary consumption of network bandwidth, increased data usage, and additional processing load, especially when the user intends to listen to or view only a single media object. Furthermore, this can lead to unwanted playback of subsequent media objects, requiring the user to manually intervene to halt playback or prevent the next item from being streamed.

By implementing a mechanism that, in response to user input, refrains from requesting or receiving any data packets for the next media object after the current media object is completed, the techniques described herein provides several technical advantages. The system avoids unnecessary network requests and data transfers for media objects that the user does not wish to play, resulting in lower bandwidth consumption and reduced data costs, which is particularly beneficial for users on metered or limited data connections. By not initiating the streaming or buffering of additional media objects, the device conserves processing resources and power, extending battery life and improving overall device performance. The user is provided with a more predictable and controllable playback experience, as the application will not proceed to the next media object unless explicitly instructed. This eliminates the need for constant user monitoring or manual intervention to stop unwanted playback. On the server side, the reduction in unnecessary streaming requests helps optimize network traffic and server load, contributing to more efficient use of infrastructure resources. By not automatically requesting additional media objects, the system may also reduce the exposure of user activity data and limit the transmission of potentially sensitive information. Overall, this technical improvement transforms the operation of streaming media applications by providing a more efficient, user-centric, and resource-conscious approach to playlist management and media delivery.

The techniques described herein center on a “play one then stop” function for media player applications. This feature allows a user to select a specific graphical icon or place a marker within a playlist, instructing the media application to continue outputting the currently playing media object to completion and then automatically halt playback, refraining from playing any subsequent media objects in the playlist. The invention further enables the user to specify, through multiple selections or marker placements, the exact number of media objects to be played before playback ceases. The system provides visual feedback by updating the appearance of the graphical icon or marker, clearly indicating the active state of the function. This approach addresses the longstanding problem of unwanted automatic continuation through a playlist, offering users precise, intuitive, and efficient control over media playback. The inventive concept is applicable to a wide range of media types, including audio, video, and images, and can be implemented across various computing devices and streaming platforms, resulting in improved user experience, reduced resource consumption, and enhanced flexibility in media consumption.

Consider a popular music streaming application installed on a user's smartphone. The user creates a playlist containing several songs to listen to while relaxing in the evening. As the user prepares to fall asleep, they wish to listen to only the current song and have playback automatically stop when the song finishes, without having to manually intervene or risk the next song playing and disturbing their rest.

With the inventive “play one then stop” system implemented, the user simply taps a dedicated graphical icon labeled “Play One Then Stop” in the application's playback controls while the current song is playing. The application visually updates the icon to indicate that the function is active. The system continues to play the current song to completion. When the song ends, the application automatically refrains from requesting or streaming the next song in the playlist, and playback stops. The user is not required to monitor the application or manually pause playback at the right moment.

If the user later decides they want to listen to two more songs before stopping, they can tap the “Play One Then Stop” icon two additional times. The application will then play the current song and the next two songs in the playlist, stopping automatically after the third song finishes.

This implementation provides the user with precise control over their listening experience, conserves device battery and data by not streaming unnecessary songs, and enhances convenience, especially in scenarios where the user may not be able to interact with the device at the exact moment playback should stop. The same system can be applied to video playlists, podcasts, or other media types, and can be integrated into a variety of devices, including smartphones, tablets, smart speakers, and connected home entertainment systems.

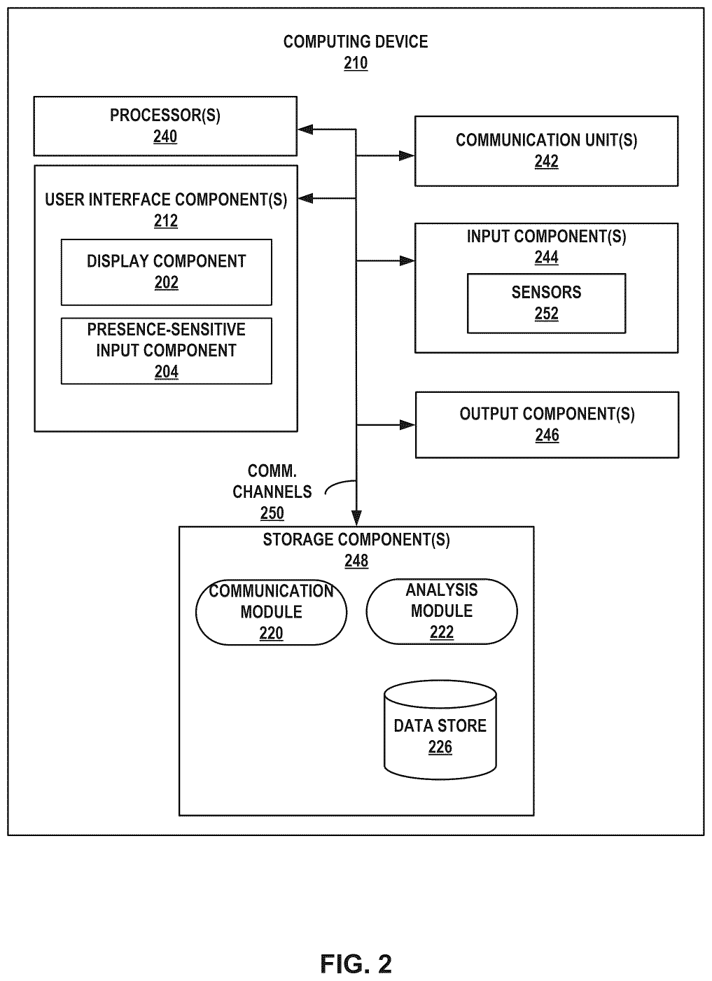

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and data store 226.

One or more processors 240 may implement functionality and/or execute instructions associated with computing device 210 to perform the techniques described herein. Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to perform the techniques described herein.

Communication module 220 may execute locally (e.g., at processors 240) to provide functions associated with performing some or all of the techniques described herein. In some examples, communication module 220 may act as an interface to a remote service accessible to computing device 210. For example, communication module 220 may be an interface or application programming interface (API) to a remote server that performs some or all of the techniques described herein.

In some examples, analysis module 222 may execute locally (e.g., at processors 240) to provide functions associated with performing some or all of the techniques described herein. In some examples, analysis module 222 may act as an interface to a remote service accessible to computing device 210. For example, analysis module 222 may be an interface or application programming interface (API) to a remote server that performs some or all of the techniques described herein.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 220 may output, via output component 246, a first media object in a media application, wherein the first media object is part of a playlist of media objects, the playlist of media objects comprising a plurality of media objects including the first media object, and wherein the media application is configured such that, when the outputting of the first media object is completed, communication module 220 would typically automatically begin outputting a second media object of the plurality of media objects in the playlist of media objects. In some instances, the first media object may include any one or more of an audio object, a video object, and an image object.

While outputting the first media object, communication module 220 may receive, within the media application, an indication of user input selecting a first graphical icon in a graphical user interface of the media application. In some instances, in response to receiving the indication of user input selecting the first graphical icon, communication module 220 may update an appearance of the first graphical icon in the graphical user interface of the media application to indicate that the playlist of media applications will cease being output by the one or more processors upon completion of the first media object. In some instances, the indication of user input is received via one or more of a voice command and a touch input.

In response to receiving the indication of user input selecting the first graphical icon, communication module 220 may continue to output the first media object in the media application until completion. When communication module 220 completes outputting the first media object, communication module 220 may refrain from outputting the second media object in the playlist of media objects.

In some instances, in response to receiving the indication of user input selecting the first graphical icon, when communication module 220 completes outputting the first media object, communication module 220 may further refrain from outputting any of the media objects in the playlist of media objects.

In some instances, after refraining from outputting the second media object in the playlist of media objects, communication module 220 may receive an indication of second user input selecting a second graphical icon in the graphical user interface of the media application. In response to receiving the indication of second user input selecting the second graphical icon, communication module 220 may output, via output component 246, the second media object in the media application.

In some instances, the media application is configured such that, when the outputting of the second media object is completed, communication module 220 automatically begins outputting a third media object of the plurality of media objects in the playlist of media objects. In such instances, communication module 220 may output, via output component 246, the first media object in the media application. Communication module 220 may receive, within the media application, a indication of second user input selecting the first graphical icon while outputting the first media object (in addition to the original user input). In response to receiving the indication of second user input, communication module 220 may continue to output the first media object and, upon completion of the first media object, output, via output component 246, the second media object in the playlist of media objects to completion. When communication module 220 completes outputting the second media object, communication module 220 may refrain from outputting the third media object in the playlist of media objects.

In some further instances, the media application is configured such that, when the outputting of the third media object is completed, communication module 220 would typically automatically begin outputting a fourth media object of the plurality of media objects in the playlist of media objects. In such instances, communication module 220 may output, via output component 246, the first media object in the media application. Communication module 220 may receive, within the media application, an indication of second user input and an indication of third user input each selecting the first graphical icon while outputting the first media object (in addition to the original received user input). In response to receiving the indication of third user input, communication module 220 may continue to output the first media object and, upon completion of the first media object. Communication module 220 may then output, via output component 246, the second media object in the playlist of media objects to completion. Communication module 220 may then output, via output component 246, the third media object in the playlist of media objects to completion. When communication module 220 completes outputting the third media object, communication module 220 may refrain from outputting the fourth media object in the playlist of media objects.

In some instances, the media application may be a media streaming application. In such instances, in response to receiving the indication of user input selecting the first graphical icon, when communication module 220 completes outputting the first media object, communication module 220 may refrain from requesting or receiving any data packets for the second media object from a server associated with the media streaming application, thereby reducing network traffic.

In some instances, communication module 220 may output a notification to the user indicating that playback will stop after the first media object.

In some instances, communication module 220 may output a prompt for authentication before enabling the function to refrain from outputting subsequent media objects.

In accordance with additional techniques of this disclosure, communication module 220 may output, via display component 246, a graphical user interface showing at least a portion of a playlist of media objects in a media application, the playlist of media objects comprising a plurality of media objects including at least a first media object and a second media object, wherein the first media object and the second media object are consecutive media objects within the playlist of media objects, and wherein the portion of the playlist of media objects displayed includes the first media object and the second media object, wherein the media application is configured such that, when the outputting of the first media object is completed, communication module 220 would typically automatically begin outputting a second media object of the plurality of media objects in the playlist of media objects. In some instances, the first media object may be any one or more of an audio object, a video object, and an image object.

Communication module 220 may receive an indication of first user input in the graphical user interface to place a graphical marker between the first media object and the second media object. In some instances, the indication of user input may be received via one or more of a voice command and a touch input.

Communication module 220 may receive an indication of second user input in the media application to begin outputting the media objects in the playlist of media objects, either before or after placing the graphical marker. Communication module 220 may output, via output component 246, the first media object in the media application, and continue to output the first media object in the media application until completion.

When communication module 220 completes outputting the first media object, communication module 220 may refrain from outputting the second media object in the playlist of media objects based on the placement of the graphical market between the first media object and the second media object in the playlist of media objects. In some instances, when communication module 220 completes outputting the first media object, communication module 220 may further refrain from outputting any of the media objects in the playlist of media objects.

In some instances, after refraining from outputting the second media object in the playlist of media objects, communication module 220 may receive an indication of second user input selecting a graphical icon in the graphical user interface of the media application. In response to receiving the indication of second user input selecting the graphical icon, communication module 220 may output, via output component 246, the second media object in the media application.

In some instances, the media application comprises a media streaming application. In such instances, in response to receiving the indication of user input selecting the first graphical icon, when communication module 220 completes outputting the first media object, communication module 220 may refrain from requesting or receiving any data packets for the second media object from a server associated with the media streaming application, thereby reducing network traffic and extraneous data transfer.

In some instances, communication module 220 may output a prompt for authentication before enabling the function to refrain from outputting subsequent media objects.

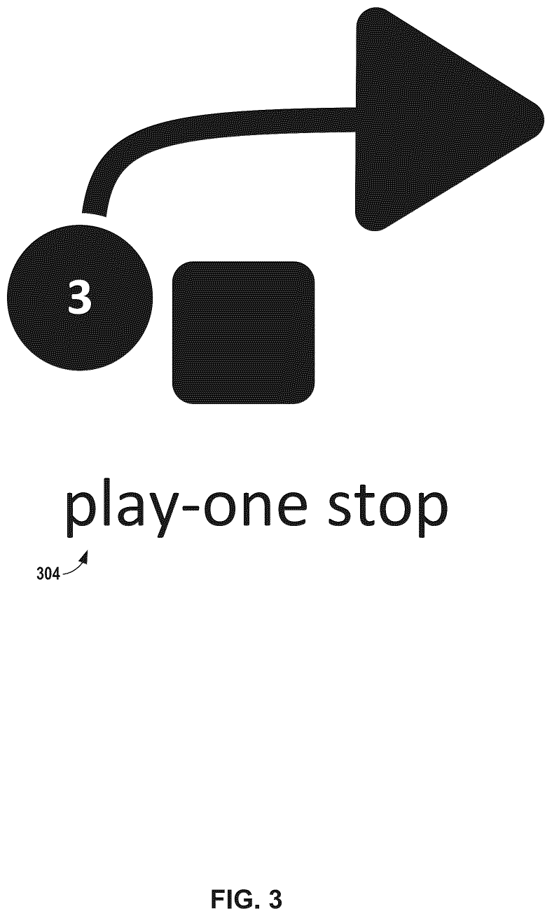

FIG. 3 is a conceptual diagram illustrating an example of a play one then stop icon 304 with an informational badge, in accordance with the techniques described herein. In some examples, the informational badge may indicate how many songs or videos are left until reaching the marker placed in the playlist that causes the output of the playlist to automatically cease rather than continue playing through the playlist, in accordance with some of the techniques described herein. This could also be for instances such as those where multiple indications of user input are received by the computing device, indicating multiple songs should be played before stopping. The number could increase with each additional indication of user input on the icon.

In accordance with the techniques described herein, play-one stop icon 304 may be presented as a graphical user interface element within a media application to enable users to control the playback behavior of a playlist of media objects. When a user provides an input selecting play-one stop icon 304, the media application is configured to continue outputting the currently playing media object until the media object reaches completion and, upon completion, refrain from outputting the next media object in the playlist. The play-one stop icon 304 thus modifies the default playback sequence by intercepting the transition from a completed media object to the subsequent media object in the playlist.

In some examples, play-one stop icon 304 is displayed as part of the graphical user interface and is accessible during playback of media objects. By default, the media application may automatically begin outputting a subsequent media object upon completion of a preceding one. However, upon receiving an indication of user input selecting play-one stop icon 304, the media application modifies this behavior such that, when one or more processors complete outputting the current media object, the next media object in the playlist is not output.

Moreover, play-one stop icon 304 may support dynamic toggling of the one-stop function during continuous playback. For instance, while outputting the first media object, the media application may receive a second indication of user input selecting play-one stop icon 304. In response, the media application continues to output the first media object to completion and then outputs the second media object in the playlist to completion, after which the third media object is withheld from output. As a result, users gain fine-grained control over successive transitions between media objects.

Furthermore, play-one stop icon 304 may handle multiple sequential user inputs to define a custom playback window. For example, the media application may receive third and fourth indications of user input, each selecting play-one stop icon 304 while outputting the first media object. In response to the third indication, the media application will output the first through third media objects in succession and then refrain from outputting the fourth media object. Accordingly, users can specify the exact number of media objects to play before cessation. That number may be reflected in the play-one stop icon 304.

In addition, play-one stop icon 304 may include visual indicators to provide feedback regarding the active state of the one-stop function. For example, the media application may update the appearance of play-one stop icon 304 to signal that playback will cease upon completion of the current media object. As a result, the user is made aware of the upcoming playback behavior, ensuring clarity and predictability in the operation of the media application.

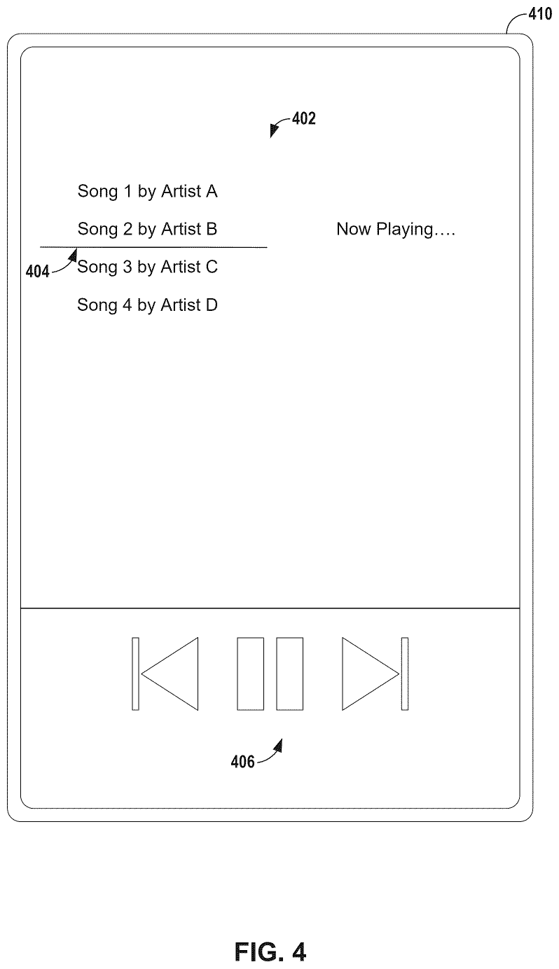

FIG. 4 is a conceptual diagram illustrating an example user interface of a music application that utilizes a graphical marker placed between songs to indicate where the playlist should stop, in accordance with one or more of the techniques of this disclosure. User interface 402 represents the graphical user interface of the media player application as displayed on computing device 410. This interface provides a visual representation of the playlist, listing media objects such as songs along with associated metadata (e.g., song title and artist). The user interface is configured to dynamically update to reflect the current playback status, such as indicating which media object is currently playing or has been selected by the user. It serves as the primary point of interaction, allowing users to view the playlist, monitor playback, and interact with playback controls and markers.

Graphical marker stop 404 is a visual indicator within the user interface 402 that designates a specific point in the playlist where playback will automatically cease. The marker may be placed by the user, for example, between two media objects, to indicate that playback should stop after the preceding media object is completed. This feature provides users with enhanced control over playback, allowing them to set a stopping point in advance without the need for manual intervention at the desired moment. The graphical marker stop may be displayed as a line, icon, or other visual element that clearly distinguishes the stopping point within the playlist.

Play/pause button 406 is a graphical control element located within user interface 402 that allows the user to start or pause playback of the selected media object. This button is typically represented by standard play and pause icons and is positioned alongside other playback controls, such as skip or previous track buttons. The play/pause button receives user input (e.g., touch or click) and communicates with the underlying media application to control the output of media objects according to the user's commands.

Computing device 410 refers to the physical hardware on which the media player application and user interface 402 are executed and displayed and is an example of computing device 110 or computing device 210. This device may be any suitable computing platform, such as a smartphone, tablet, laptop, desktop computer, or smart home device. Computing device 410 includes the necessary processing, storage, input, and output components to support the operation of the media application, display the user interface, and receive user input through touch, voice, or other modalities. The device frame defines the visible area for the user interface and houses the hardware required for media playback and user interaction.

In accordance with the techniques described herein, user interface 402 may be rendered on computing device 410 to facilitate user interaction with a media application. In some examples, user interface 402 may present at least a portion of a playlist of media objects, the playlist comprising a plurality of media objects including at least a first media object and a second media object. For each of the plurality of media objects, user interface 402 may display metadata associated with the respective media object, such as a title, an artist, and a playback status. Accordingly, when outputting of the first media object is completed, the one or more processors of computing device 410 may automatically begin outputting the second media object of the plurality of media objects in the playlist.

In some examples, graphical marker stop 404 may be provided as an interactive element within user interface 402 to allow a user to place a graphical marker between the first media object and the second media object in the playlist. Graphical marker stop 404 is configured to receive an indication of first user input in user interface 402 to place the marker. If the user places the graphical marker stop 404 between the first media object and the second media object, graphical marker stop 404 serves as a control mechanism to indicate that playback is to cease after completion of the first media object, refraining from outputting the second media object based on the placement of the graphical marker stop 404. As a result, graphical marker stop 404 provides a visual representation of the user's intent to stop playback at a specific point in the playlist, thereby enhancing the functionality of the media application.

Accordingly, play/pause button 406 may be provided as another interactive element within user interface 402 to allow the user to control playback of media objects. Play/pause button 406 is configured to receive an indication of second user input in the media application to begin or pause outputting the media objects in the playlist. When activated, play/pause button 406 enables the user to start or pause playback of the first media object. Furthermore, play/pause button 406 may provide tactile or visual feedback to indicate the current state of the button. As a result, play/pause button 406 interacts with graphical marker stop 404 and other elements of user interface 402 to facilitate seamless playback control.

In some examples, computing device 410 may serve as the hardware platform on which the media application and user interface 402 are executed. Computing device 410 may include one or more processors, input/output components, and storage components that enable execution of the media application and display of user interface 402. For example, processors of computing device 410 may receive user input via graphical marker stop 404 and play/pause button 406, process the input, and perform actions such as outputting the first media object, refraining from outputting the second media object, and updating user interface 402 accordingly.

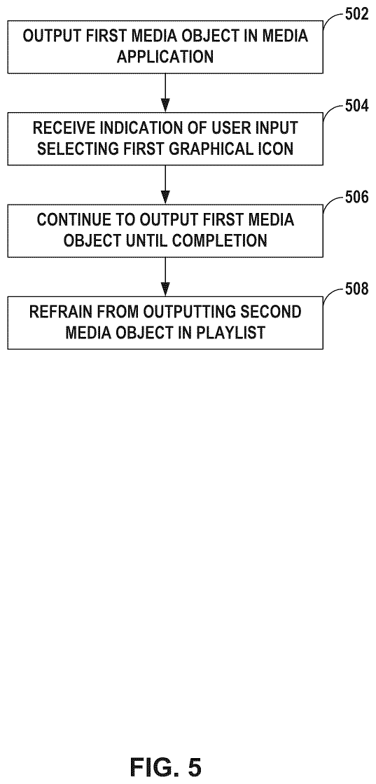

FIG. 5 is a flow chart illustrating an example mode of operation. The techniques of FIG. 5 may be performed by one or more processors of a computing device, such as system 100 of FIG. 1 and/or computing device 210 illustrated in FIG. 2. For purposes of illustration only, the techniques of FIG. 5 are described within the context of computing device 210 of FIG. 2, although computing devices having configurations different than that of computing device 210 may perform the techniques of FIG. 5.

In accordance with the techniques of this disclosure, communication module 220 outputs, via output component 246, a first media object in a media application, wherein the first media object is part of a playlist of media objects, the playlist of media objects comprising a plurality of media objects including the first media object, and wherein the media application is configured such that, when the outputting of the first media object is completed, communication module 220 would typically automatically begin outputting a second media object of the plurality of media objects in the playlist of media objects (502). While outputting the first media object, communication module 220 receives, within the media application, an indication of user input selecting a first graphical icon in a graphical user interface of the media application (504). In response to receiving the indication of user input selecting the first graphical icon, communication module 220 continues to output the first media object in the media application until completion (506) and, when communication module 220 completes outputting the first media object, refrains from outputting the second media object in the playlist of media objects (508).

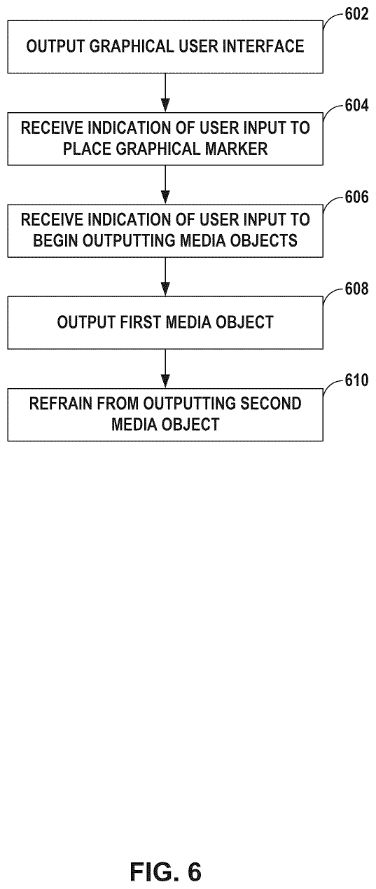

FIG. 6 is a flow chart illustrating an example mode of operation. The techniques of FIG. 6 may be performed by one or more processors of a computing device, such as system 100 of FIG. 1 and/or computing device 210 illustrated in FIG. 2. For purposes of illustration only, the techniques of FIG. 6 are described within the context of computing device 210 of FIG. 2, although computing devices having configurations different than that of computing device 210 may perform the techniques of FIG. 6.

In accordance with the techniques of this disclosure, communication module 220 outputs, via a display component, a graphical user interface showing at least a portion of a playlist of media objects in a media application, the playlist of media objects comprising a plurality of media objects including at least a first media object and a second media object, wherein the first media object and the second media object are consecutive media objects within the playlist of media objects, and wherein the portion of the playlist of media objects displayed includes the first media object and the second media object, wherein the media application is configured such that, when the outputting of the first media object is completed, communication module 220 would typically automatically begin outputting a second media object of the plurality of media objects in the playlist of media objects (602). Communication module 220 receives an indication of first user input in the graphical user interface to place a graphical marker between the first media object and the second media object (604). Communication module 220 receives an indication of second user input in the media application to begin outputting the media objects in the playlist of media objects (606). Communication module 220 outputs, via output component 246, the first media object in the media application until completion (608). When communication module 220 completes outputting the first media object, communication module 220 refrains from outputting the second media object in the playlist of media objects based on the placement of the graphical market between the first media object and the second media object in the playlist of media objects (610).

Example 1: A method comprising: outputting, by one or more processors and via an output component, a first media object in a media application, wherein the first media object is part of a playlist of media objects, the playlist of media objects comprising a plurality of media objects including the first media object, and wherein the media application is configured such that, when the outputting of the first media object is completed, the one or more processors automatically begin outputting a second media object of the plurality of media objects in the playlist of media objects; while outputting the first media object, receiving, by the one or more processors and within the media application, an indication of user input selecting a first graphical icon in a graphical user interface of the media application; and in response to receiving the indication of user input selecting the first graphical icon: continuing, by the one or more processors, to output the first media object in the media application until completion; and when the one or more processors complete outputting the first media object, refraining, by the one or more processors, from outputting the second media object in the playlist of media objects.

Example 2: The method of claim 1, further comprising: in response to receiving the indication of user input selecting the first graphical icon, when the one or more processors complete outputting the first media object, refraining, by the one or more processors, from outputting any of the media objects in the playlist of media objects.

Example 3: The method of any one or more of claims 1-2, wherein the first media object comprises any one or more of: an audio object, a video object, and an image object.

Example 4: The method of any one or more of claims 1-3, further comprising: in response to receiving the indication of user input selecting the first graphical icon, updating, by the one or more processors, an appearance of the first graphical icon in the graphical user interface of the media application to indicate that the playlist of media applications will cease being output by the one or more processors upon completion of the first media object.

Example 5: The method of any one or more of claims 1-4, further comprising: after refraining from outputting the second media object in the playlist of media objects, receiving, by the one or more processors, an indication of second user input selecting a second graphical icon in the graphical user interface of the media application; and in response to receiving the indication of second user input selecting the second graphical icon, outputting, by the one or more processors and via the output component, the second media object in the media application.

Example 6: The method of any one or more of Examples 1-5, wherein the media application is configured such that, when the outputting of the second media object is completed, the one or more processors automatically begin outputting a third media object of the plurality of media objects in the playlist of media objects, and wherein the method further comprises: outputting, by the one or more processors and via the output component, the first media object in the media application; receiving, by the one or more processors and within the media application, a indication of second user input selecting the first graphical icon while outputting the first media object; and in response to receiving the indication of second user input: continuing, by the one or more processors, to output the first media object and, upon completion of the first media object; outputting, by the one or more processors and via the output component, the second media object in the playlist of media objects to completion; and when the one or more processors complete outputting the second media object, refraining, by the one or more processors, from outputting the third media object in the playlist of media objects.

Example 7: The method of Example 6, wherein the media application is configured such that, when the outputting of the third media object is completed, the one or more processors automatically begin outputting a fourth media object of the plurality of media objects in the playlist of media objects, and wherein the method further comprises: outputting, by the one or more processors and via the output component, the first media object in the media application; receiving, by the one or more processors and within the media application, an indication of second user input and an indication of third user input each selecting the first graphical icon while outputting the first media object; and in response to receiving the indication of third user input: continuing, by the one or more processors, to output the first media object and, upon completion of the first media object; outputting, by the one or more processors and via the output component, the second media object in the playlist of media objects to completion; outputting, by the one or more processors and via the output component, the third media object in the playlist of media objects to completion; and when the one or more processors complete outputting the third media object, refraining, by the one or more processors, from outputting the fourth media object in the playlist of media objects.

Example 8: The method of any one or more of Examples 1-7, wherein the media application comprises a media streaming application, and wherein the method further comprises: in response to receiving the indication of user input selecting the first graphical icon, when the one or more processors complete outputting the first media object, refraining, by the one or more processors, from requesting or receiving any data packets for the second media object from a server associated with the media streaming application.

Example 9: The method of any one or more of Examples 1-8, further comprising: outputting, by the one or more processors, a notification to the user indicating that playback will stop after the first media object.

Example 10: The method of any one or more of Examples 1-9, wherein the indication of user input is received via one or more of a voice command and a touch input.

Example 11: The method of any one or more of Examples 1-10, further comprising: outputting, by the one or more processors, a prompt for authentication before enabling the function to refrain from outputting subsequent media objects.

Example 12: A method comprising: outputting, by the one or more processors and via a display component, a graphical user interface showing at least a portion of a playlist of media objects in a media application, the playlist of media objects comprising a plurality of media objects including at least a first media object and a second media object, wherein the first media object and the second media object are consecutive media objects within the playlist of media objects, and wherein the portion of the playlist of media objects displayed includes the first media object and the second media object, wherein the media application is configured such that, when the outputting of the first media object is completed, the one or more processors automatically begin outputting a second media object of the plurality of media objects in the playlist of media objects; receiving, by the one or more processors, an indication of first user input in the graphical user interface to place a graphical marker between the first media object and the second media object; receiving, by the one or more processors, an indication of second user input in the media application to begin outputting the media objects in the playlist of media objects; outputting, by the one or more processors and via an output component, the first media object in the media application; continuing, by the one or more processors, to output the first media object in the media application until completion; and when the one or more processors complete outputting the first media object, refraining, by the one or more processors, from outputting the second media object in the playlist of media objects based on the placement of the graphical market between the first media object and the second media object in the playlist of media objects.

Example 13: The method of Example 12, further comprising: when the one or more processors complete outputting the first media object, refraining, by the one or more processors, from outputting any of the media objects in the playlist of media objects.

Example 14: The method of any one or more of Examples 12-13, wherein the first media object comprises any one or more of: an audio object, a video object, and an image object.

Example 15: The method of any one or more of Examples 12-14, further comprising: after refraining from outputting the second media object in the playlist of media objects, receiving, by the one or more processors, an indication of second user input selecting a graphical icon in the graphical user interface of the media application; and in response to receiving the indication of second user input selecting the graphical icon, outputting, by the one or more processors and via the output component, the second media object in the media application.

Example 16: The method of any one or more of Examples 12-15, wherein the media application comprises a media streaming application, and wherein the method further comprises: in response to receiving the indication of user input selecting the first graphical icon, when the one or more processors complete outputting the first media object, refraining, by the one or more processors, from requesting or receiving any data packets for the second media object from a server associated with the media streaming application.

Example 17: The method of any one or more of Examples 12-16, wherein the indication of user input is received via one or more of a voice command and a touch input.

Example 18: The method of any one or more of Examples 12-17, further comprising: outputting, by the one or more processors, a prompt for authentication before enabling the function to refrain from outputting subsequent media objects.

Example 19: A non-transitory computer-readable storage medium having stored thereon instructions that, when executed, cause one or more processors of a computing device to: output, via an output component, a first media object in a media application, wherein the first media object is part of a playlist of media objects, the playlist of media objects comprising a plurality of media objects including the first media object, and wherein the media application is configured such that, when the outputting of the first media object is completed, the one or more processors automatically begin outputting a second media object of the plurality of media objects in the playlist of media objects; while outputting the first media object, receive, within the media application, an indication of user input selecting a first graphical icon in a graphical user interface of the media application; and in response to receiving the indication of user input selecting the first graphical icon: continue to output the first media object in the media application until completion; and when the one or more processors complete outputting the first media object, refrain from outputting the second media object in the playlist of media objects.

Example 20: The non-transitory computer-readable storage medium of Example 19, wherein the instructions, when executed, further cause the one or more processors to: in response to receiving the indication of user input selecting the first graphical icon, when the one or more processors complete outputting the first media object, refrain from outputting any of the media objects in the playlist of media objects.

Example 21: A method for performing any of the techniques of any combination of Examples 1-9.

Example 22: A device configured to perform any of the methods of any combination of Examples 1-18.

Example 23: An apparatus comprising means for performing any of the method of any combination of Examples 1-18.

Example 24: A non-transitory computer-readable storage medium having stored thereon instructions that, when executed, cause one or more processors of a computing device to perform the method of any combination of Examples 1-18.

Example 25: A system comprising one or more computing devices configured to perform a method of any combination of Examples 1-18.

Example 26: Any of the techniques described herein.

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount-including any integer-between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A method comprising:
outputting, by one or more processors and via an output component, a first media object in a media application, wherein the first media object is part of a playlist of media objects, the playlist of media objects comprising a plurality of media objects including the first media object, and wherein the media application is configured such that, when the outputting of the first media object is completed, the one or more processors automatically begin outputting a second media object of the plurality of media objects in the playlist of media objects;
while outputting the first media object, receiving, by the one or more processors and within the media application, an indication of user input selecting a first graphical icon in a graphical user interface of the media application; and
in response to receiving the indication of user input selecting the first graphical icon:
continuing, by the one or more processors, to output the first media object in the media application until completion; and
when the one or more processors complete outputting the first media object, refraining, by the one or more processors, from outputting the second media object in the playlist of media objects.

2. The method of claim 1, further comprising:
in response to receiving the indication of user input selecting the first graphical icon, when the one or more processors complete outputting the first media object, refraining, by the one or more processors, from outputting any of the media objects in the playlist of media objects.

3. The method of claim 1, wherein the first media object comprises any one or more of:
an audio object,
a video object, and
an image object.

4. The method of claim 1, further comprising:
in response to receiving the indication of user input selecting the first graphical icon, updating, by the one or more processors, an appearance of the first graphical icon in the graphical user interface of the media application to indicate that the playlist of media applications will cease being output by the one or more processors upon completion of the first media object.

5. The method of claim 1, further comprising:
after refraining from outputting the second media object in the playlist of media objects, receiving, by the one or more processors, an indication of second user input selecting a second graphical icon in the graphical user interface of the media application; and
in response to receiving the indication of second user input selecting the second graphical icon, outputting, by the one or more processors and via the output component, the second media object in the media application.

6. The method of claim 1, wherein the media application is configured such that, when the outputting of the second media object is completed, the one or more processors automatically begin outputting a third media object of the plurality of media objects in the playlist of media objects, and wherein the method further comprises:
outputting, by the one or more processors and via the output component, the first media object in the media application;
receiving, by the one or more processors and within the media application, a indication of second user input selecting the first graphical icon while outputting the first media object; and
in response to receiving the indication of second user input:
continuing, by the one or more processors, to output the first media object and, upon completion of the first media object;
outputting, by the one or more processors and via the output component, the second media object in the playlist of media objects to completion; and
when the one or more processors complete outputting the second media object, refraining, by the one or more processors, from outputting the third media object in the playlist of media objects.

7. The method of claim 6, wherein the media application is configured such that, when the outputting of the third media object is completed, the one or more processors automatically begin outputting a fourth media object of the plurality of media objects in the playlist of media objects, and wherein the method further comprises:
outputting, by the one or more processors and via the output component, the first media object in the media application;
receiving, by the one or more processors and within the media application, an indication of second user input and an indication of third user input each selecting the first graphical icon while outputting the first media object; and
in response to receiving the indication of third user input:
continuing, by the one or more processors, to output the first media object and, upon completion of the first media object;
outputting, by the one or more processors and via the output component, the second media object in the playlist of media objects to completion;
outputting, by the one or more processors and via the output component, the third media object in the playlist of media objects to completion; and
when the one or more processors complete outputting the third media object, refraining, by the one or more processors, from outputting the fourth media object in the playlist of media objects.

8. The method of claim 1, wherein the media application comprises a media streaming application, and wherein the method further comprises:
in response to receiving the indication of user input selecting the first graphical icon, when the one or more processors complete outputting the first media object, refraining, by the one or more processors, from requesting or receiving any data packets for the second media object from a server associated with the media streaming application.

9. The method of claim 1, further comprising:
outputting, by the one or more processors, a notification to the user indicating that playback will stop after the first media object.

10. The method of claim 1, wherein the indication of user input is received via one or more of a voice command and a touch input.

11. The method of claim 1, further comprising:
outputting, by the one or more processors, a prompt for authentication before enabling the function to refrain from outputting subsequent media objects.

12. A method comprising:
outputting, by the one or more processors and via a display component, a graphical user interface showing at least a portion of a playlist of media objects in a media application, the playlist of media objects comprising a plurality of media objects including at least a first media object and a second media object, wherein the first media object and the second media object are consecutive media objects within the playlist of media objects, and wherein the portion of the playlist of media objects displayed includes the first media object and the second media object, wherein the media application is configured such that, when the outputting of the first media object is completed, the one or more processors automatically begin outputting a second media object of the plurality of media objects in the playlist of media objects;
receiving, by the one or more processors, an indication of first user input in the graphical user interface to place a graphical marker between the first media object and the second media object;
receiving, by the one or more processors, an indication of second user input in the media application to begin outputting the media objects in the playlist of media objects;
outputting, by the one or more processors and via an output component, the first media object in the media application;
continuing, by the one or more processors, to output the first media object in the media application until completion; and
when the one or more processors complete outputting the first media object, refraining, by the one or more processors, from outputting the second media object in the playlist of media objects based on the placement of the graphical market between the first media object and the second media object in the playlist of media objects.

13. The method of claim 12, further comprising:
when the one or more processors complete outputting the first media object, refraining, by the one or more processors, from outputting any of the media objects in the playlist of media objects.

14. The method of claim 12, wherein the first media object comprises any one or more of:
an audio object,
a video object, and
an image object.

15. The method of claim 12, further comprising:
after refraining from outputting the second media object in the playlist of media objects, receiving, by the one or more processors, an indication of second user input selecting a graphical icon in the graphical user interface of the media application; and
in response to receiving the indication of second user input selecting the graphical icon, outputting, by the one or more processors and via the output component, the second media object in the media application.

16. The method of claim 12, wherein the media application comprises a media streaming application, and wherein the method further comprises:
in response to receiving the indication of user input selecting the first graphical icon, when the one or more processors complete outputting the first media object, refraining, by the one or more processors, from requesting or receiving any data packets for the second media object from a server associated with the media streaming application.

17. The method of claim 12, wherein the indication of user input is received via one or more of a voice command and a touch input.

18. The method of claim 12, further comprising:
outputting, by the one or more processors, a prompt for authentication before enabling the function to refrain from outputting subsequent media objects.

19. A non-transitory computer-readable storage medium having stored thereon instructions that, when executed, cause one or more processors of a computing device to:
output, via an output component, a first media object in a media application, wherein the first media object is part of a playlist of media objects, the playlist of media objects comprising a plurality of media objects including the first media object, and wherein the media application is configured such that, when the outputting of the first media object is completed, the one or more processors automatically begin outputting a second media object of the plurality of media objects in the playlist of media objects;
while outputting the first media object, receive, within the media application, an indication of user input selecting a first graphical icon in a graphical user interface of the media application; and
in response to receiving the indication of user input selecting the first graphical icon:
continue to output the first media object in the media application until completion; and
when the one or more processors complete outputting the first media object, refrain from outputting the second media object in the playlist of media objects.

20. The non-transitory computer-readable storage medium of claim 19, wherein the instructions, when executed, further cause the one or more processors to:
in response to receiving the indication of user input selecting the first graphical icon, when the one or more processors complete outputting the first media object, refrain from outputting any of the media objects in the playlist of media objects.
